(19) United States
(12) Patent Application Publication
(10) Pub. No.: US 2003/0166403 A1
(43) Pub. Date: Sep. 4, 2003

(54) INTERNATIONAL TEMPORARY LOCAL DIRECTORY NUMBER (TLDN) TRANSLATOR

(76) Inventors: KENNETH WAYNE HAMMER, LUTZ, FL (US); ALLEN AMROLLAH HEMMAT, TAMPA, FL (US); GEORGIENE LOUISE WAGNER, ST. PETERSBURG, FL (US)

Correspondence Address: Finnegan Henderson Farabow Garrett & Dunner LLP, 1300 I Street NW, Washington, DC, 20005-3315, US

(21) Appl. No.: 09/330,119

(22) Filed: Jun. 10, 1999

(51) Int. Cl. H04Q 7/20

(52) U.S. Cl. 455/445; 455/453

(57) ABSTRACT

A system equipped with methods and an International Temporary Local Directory Number (TLDN) Translator. In accordance with one aspect of the invention, a device in a home domain uses the International TLDN Translator to receive operative routing information to a mobile phone roaming in a serve domain. The calling device contacts the local Public Switching Telephone Network (PSTN) with a request to contact the roaming mobile phone in the serve domain. Mobile Switching Center (MSC) sends a routing request to the International TLDN Translator, which forwards the request to the serve domain. The serve domain responds with a TLDN of the roaming mobile phone located in the serve domain. The International TLDN Translator modifies the TLDN to create a pseudo-TLDN that is operative from the home domain, such that a device in the home domain can contact the roaming mobile phone. The modification of the TLDN is performed by determining the dialing characteristics between the home domain and the serve domain.

### BACKGROUND OF THE INVENTION

A. Field of the Invention

This invention relates to call routing and, particularly, to routing a call to a mobile phone that is roaming in a domain different from the mobile home's domain.

B. Description of the Related Art

As mobile phone usage has increased, people have become more dependent on the ability to contact others using their mobile phone at anytime, any place and anywhere. People use their mobile phones for business and pleasure and have adopted their use not just in a local city or town, but have become accustomed to using them while they are “roaming,” i.e., outside of their local area. Telephone networks have become more adept at routing information to these mobile phones that are roaming. National networks have been established so that a person with a mobile phone can now travel all over a country and calls can be routed to him or her as if he or she was in a local area.

These national telephone networks use a signaling protocol, e.g., ANSI-41, in order to route the information necessary to transfer a call located in one area and reach the roaming mobile phone in another area. However, in most current implementations, these routing schemes work when the caller and the roaming mobile phone are contained within a single domain. A domain is defined as a numbering plan area, such as the North American Numbering Plan (NANP) area for telephony. To address the mobile phone roaming, switches within a domain utilize a scheme involving temporary local directory numbers (TLDN). When informed via signaling that there is a call for a mobile phone roaming within its coverage area, a local switch will assign a TLDN to this mobile phone. This TLDN is used by the wireless switch in the subscriber home domain to deliver the call to the roamer. After the call is connected to the wireless phone the switch releases that TLDN and can then use that TLDN to connect a call to another wireless phone roaming in its area. All the TLDNs assigned to switches in the entire network are unique within a domain.

However, a problem arises when the mobile phone is roaming in a separate domain. The TLDN assigned by the visiting switch can not always be utilized by a switch in the home domain. It may need to be modified by adding or deleting certain digits to it in order for it to be operable in the home domain. This conflict is one reason why roaming between separate domains is currently not supported by a roaming network. Consequently, those with mobile phones in one domain cannot take advantage of their mobile phone when they roam into another domain. For example, business travelers who travel internationally, and are used to taking advantage of their mobile phone when they travel within a domain, cannot take advantage of their mobile phone when they cross into a country that is defined by a different domain. This issue has been addressed by the standard organizations. Signaling standards have been enhanced so that the TLDN provided by a wireless switch in one domain would be operable in another domain. This however means that both the home and serve domain switches should upgrade their systems to be able to operate according to the enhanced standard. Since the upgrade of switch signaling software involves cost and possible service interruption, it would be many years till switches in all countries would be upgraded. As long as the switches in the home or visiting domains are not both upgraded to the new standard, there will be a need for modification and manipulation of the routing information provided by the switch in the serving domain in order to be operative by the switch in the home domain.

When addressing the issue of routing information between different domains, there may be several modifications to the routing information that may need to be made in order to reach the phone in another domain. For example, if a person is placing a call via landline from a home domain, defined as the U.S., and dials a phone in Hong Kong, a separate domain, the person placing the call must add the numbers “011” to the beginning of the phone number in order to identify to the local phone network that an international call is being placed. In addition, because of the fact the phone is in Hong Kong, an “8” must be included before dialing the phone number in order to reach a phone that is located in Hong Kong.

However, if in the above example the home domain was Venezuela, the modifications to the destination number would have to be the addition of “00”, identifying it to the home Venezuelan phone network as an international call, as well as the addition of an “8” prior to dialing the destination number. Consequently, the determination of how to modify the dialing pattern required to reach a mobile phone is dependent on the home domain where the call is being made from and the location of the serve domain, i.e., the location where the mobile phone is residing. Because there are so many different domains in the world, the number of home/serve domain combinations is extensive.

FIG. 1 is a block diagram depicting the conventional TLDNs in different domains. In today's system, when a call is made to a temporary device 115 then one of the TLDNs 110 located in switch 130 within a domain 100 is allocated to the temporary device 115. The domain 100 may contain multiple switches. This TLDN 110 is freed up when the incoming call is connected. When the temporary device 115 has moved to another switch in the area, and another call is made to the temporary device 115, the switch associated with the new coverage area will assign a TLDN 110 associated with that switch 130.

The operation of assigning TLDNs is similar within the different domains 100 and 105. Therefore, Domain 2 105 operates to assign TLDNs 120 to temporary devices 125 that operate within the switch's 140 coverage area. Those skilled in the art will recognize that while only one switch is shown within each domain depicted in FIG. 1, that a network associated with one domain will typically contain multiple switches and multiple temporary devices that transfer from one switch to another within the domain.

The problem depicted in FIG. 1 is when one of the temporary devices associated with a switch in Domain 1 100 travels to Domain 2 105, where Domain 2 105 is not within the same numbering plan as Domain 1 100. For example, a temporary device associated with Domain 1 100 which is in the United States and the NANP, travels to Domain 2 105 which is located in Germany. The TLDN 120, which would be sent via signaling from Domain 2 105 to Domain 1 100 when Domain 1 100 indicated via signaling that a call was waiting for delivery to the temporary device 125, would be of a configuration not understood to Domain 1 100 and the waiting call could not be delivered.

Therefore what is needed in the art is a system and a method by which a temporary device, e.g., a roaming mobile phone, can receive calls while roaming in one domain from a device located in a domain with a different numbering plan. In addition, the solution to this problem needs not to overburden local switches contained within a specific domain.

### SUMMARY OF THE INVENTION

Methods, systems and articles of manufacture consistent with the present invention overcome the shortcomings of existing systems by providing a routing information translator that modifies routing information from one domain so that it is operative from another domain. Such methods, systems and articles of manufacture consistent with the present invention performs the translation, minimizing the overhead burden on switches contained in the network and as a result reducing administrative and operational cost of carriers.

Systems and methods consistent with the present invention will provide interoperability between varying revisions of ANSI-41 standard implementations as it relates to call routing and TLDNs. Systems and methods consistent with the present invention will make the decision as to which level of TLDN the switch in home domain can receive and what type of TLDN has been sent. The received TLDN will then be passed through as received if it is at the highest capability of the home switch or manipulated to provide the highest level TLDN that the switch in the home domain can utilize.

In accordance with one aspect of the present invention, as embodied and broadly described herein, a method for determining an operative routing number for a home domain to contact a device in a serve domain comprises the steps of receiving a request for a routing number for a device located in the serve domain, receiving the routing number from the serve domain, which may or may not be operative from the home domain, modifying the routing number when necessary to create a routing number that is operative from the home domain for the device and delivering the original or modified operative routing number to the home domain. The routing number may be modified by determining the identities of the serve domain and the home domain, the capabilities of the home domain determining dialing characteristics from the home domain to the serve domain and modifying the routing number when required using the home and serve domain's routing characteristics. The original routing number is a Temporary Local Directory Number (TLDN) and the operative routing number, if modified, is referred to as a pseudo-TLDN. In accordance with another aspect of the present invention, as embodied and broadly described herein, a method of passing routing information for a roaming device located in a serve domain from a device located in a home domain, comprises receiving, by a call processor from a mobile switching center (MSC) servicing a home domain or its associated HLR, a routing request to contact the roaming device, transporting to an MSC in the serve domain the routing request, receiving by the call processor from the serve domain MSC a Temporary Local Directory Number (TLDN) for the roaming device, creating a pseudo-TLDN when required by modifying the TLDN such that the pseudo-TLDN can be dialed from the home domain and reach the roaming device in the serve domain, and delivering the pseudo-TLDN to the home domain MSC or passing the received TLDN without modification when the home capabilities can utilize it. The home domain and the serve domain may exist in separate countries and have separate numbering plans.

In accordance with yet another aspect of the present invention, as embodied and broadly described herein, a method for creating a pseudo-TLDN so that a device in a home domain may contact a roaming device in a serve domain, comprises receiving a routing request from a home domain, requesting a TLDN from the serve domain, receiving a TLDN for the roaming device in the serve domain, determining the identity of the serve domain and the home domain, determining dialing characteristics when dialing from the home domain to the serve domain and modifying the TLDN using the home and serve domains' characteristics to create the pseudo-TLDN. The roaming device may be a mobile phone. In addition, the step of modifying the TLDN may be performed by an International TLDN Translator. The identity of the server domain may be retrieved from a generic location register and the identity of the home domain may be retrieved from the routing request received from the home domain or from a data base utilizing the Mobile Identification Number (MIN) of the phone.

### BRIEF DESCRIPTION OF THE DRAWINGS

The accompanying drawings, which are incorporated in and constitute a part of the specification, illustrate presently preferred embodiments of the invention and, together with the general description given above and the detailed description of the preferred embodiments given below, serve to explain the principles of the invention. In the drawings,

FIG. 1 is a block diagram depicting the conventional use of TLDNs in multiple domains;

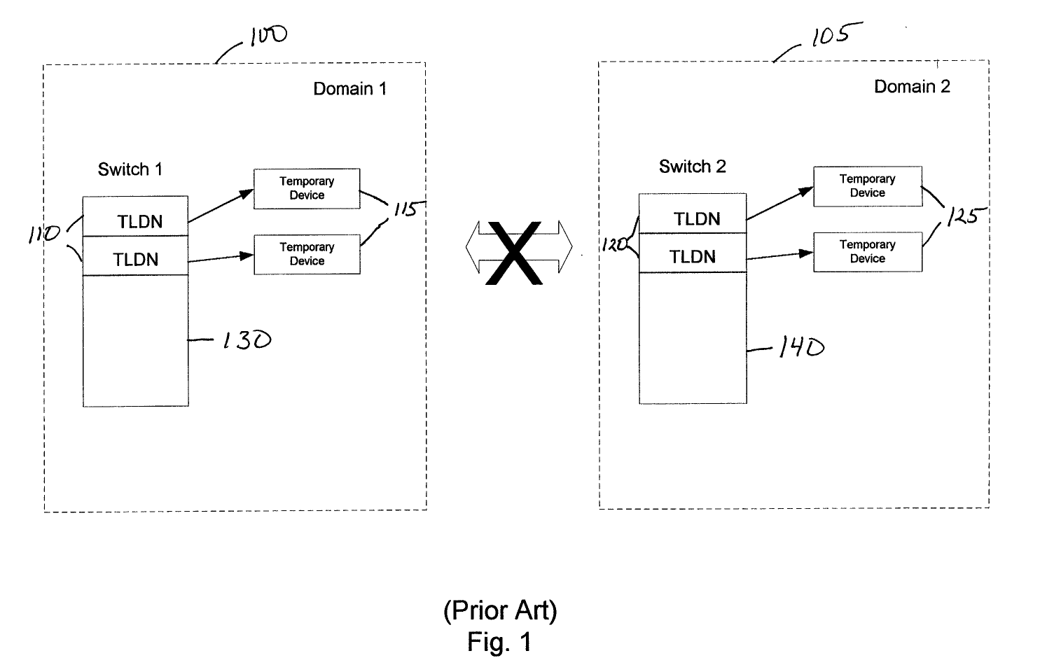

FIG. 2 is a block diagram of an International TLDN Translator connecting multiple domains in an exemplary embodiment of the present invention;

FIG. 3 is a flowchart of the high level steps performed by the International TLDN Translator in an exemplary embodiment of the present invention;

FIG. 4 is a pictorial diagram of a system implementing the international TLDN translation in an exemplary embodiment of the present invention;

FIG. 5 is a flowchart of the steps performed to implement the international TLDN translation in the International TLDN Translator in the exemplary embodiment of the present invention; and

FIG. 6 is a flowchart depicting the steps performed by the International TLDN Translator to create the pseudo-TLDN in an exemplary of the embodiment of the present invention.

### DETAILED DESCRIPTION

Reference will now be made in detail to the presently preferred embodiments of the invention as illustrated in the accompanying drawings, in which like reference characters designate like or corresponding parts throughout the several drawings.

Introduction

Systems and methods consistent with the present invention translate routing information, e.g., TLDN's, for a device supplied by one domain so that it is operative in another domain. Routing information operative within one domain is generally inoperative when used by another domain with a differing numbering plan. Such systems and methods consistent with the present invention collect the routing information supplied by the serve domain and determines the type of TLDN supplied, identifies the capabilities of the home domain, and manipulates the serve domain routing information when required so that it is operative from the home domain.

In more detail, an International TLDN Translator is used to collect the routing information of the home and serve identities. The International TLDN Translator uses this information and dialing characteristics contained in a database to determine the dialing capabilities in the home domain to the serve domain and what types of modifications to the routing information if any are needed. After determining the capabilities and dialing characteristics between the home and serve domain, the International TLDN Translator then manipulates the routing information if required so that it is operative from within the home domain to contact the device located in the serve domain.

International TLDN Translator

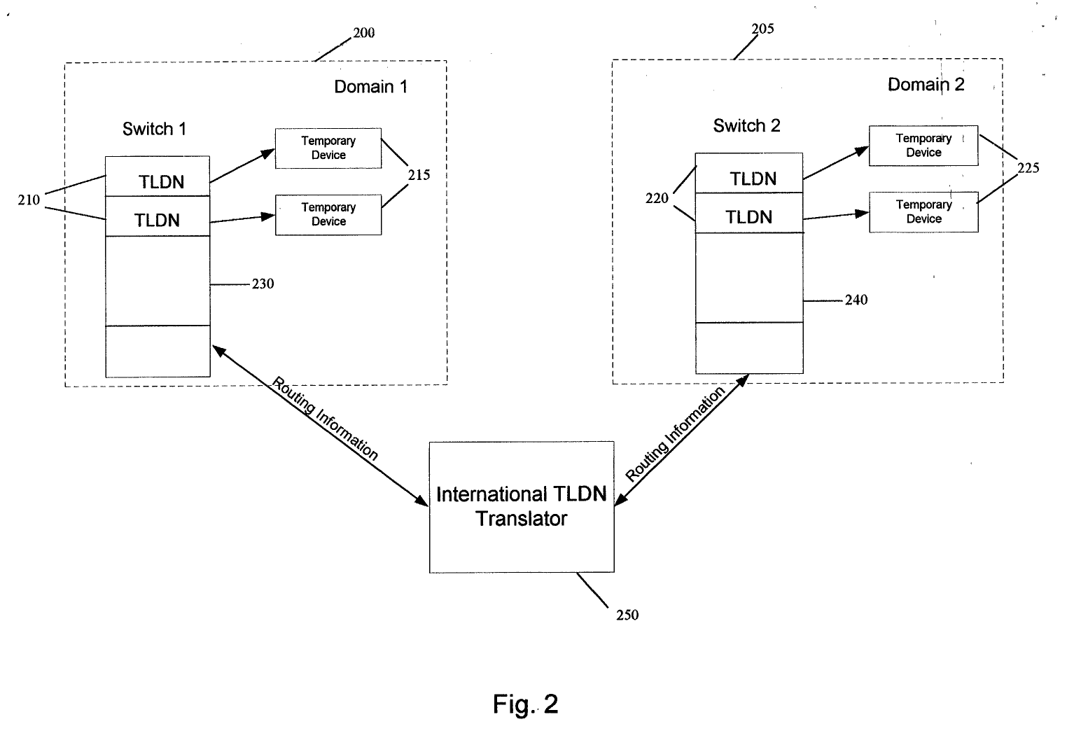

FIG. 2 is a block diagram of an International TLDN Translator connecting multiple domains in an exemplary embodiment of the present invention. In one embodiment, the International TLDN Translator 250 is embodied in a call processor developed by GTE's Telecommunications Services Incorporated, Tampa, Fla. FIG. 2 shows Domain 1 200 and Domain 2 205 representing separate domains having a switch and its associated databases contained within each domain. Each domain may have its own network and allows for the roaming of a local device, e.g., a roaming mobile phone, within the domain itself Those skilled in the art will recognize that while only one switch is identified in each domain in FIG. 2, that typically a telephone network will contain multiple switches and potentially hubs and subswitches that are involved in routing information between two devices.

To utilize the International TLDN Translator 250, switch 1 230 and its associated HLR use the International TLDN Translator 250 in order to get routing information for delivering a call to a temporary device 225 located in domain 2 205 via switch 2 240. While FIG. 2 only indicates that a temporary device is connected to switch 1, it will be recognized that it could be any device, whether it be temporary or permanent, and that switch 1 will have access to the International TLDN Translator 250 and will be able to receive routing information to route calls to all other domains that use the International TLDN Translator 250.

Switch 230 which receives routing information from the International TLDN Translator 250 can dial into the Domain 2, similarly as today with the standard landlines and the public switch network.

The International TLDN Translator 250 will have access to a database containing all the combinations necessary that allow it to determine the need and manipulate the routing information so that the routing information from one domain is operative from a second domain. The majority of ANSI 41 implementations today do not support the sending and receiving of an internationally formatted TLDN. Therefore, with international roaming, the routing information that comes in from one domain is not generally operative from a second domain. When sending that routing information, a specific domain may not provide any additional or changed digits that will need to be dialed to access the specific domain from another domain. For example, one domain may provide a ten-digit number to access a device if calling from within that domain, but additions or different digits may be required when calling from a separate domain.

In one embodiment of the present invention, an International TLDN Translator 250 will include a database capable of identifying need and type of the manipulations necessary from one domain in order that routing information is operative from a second domain.

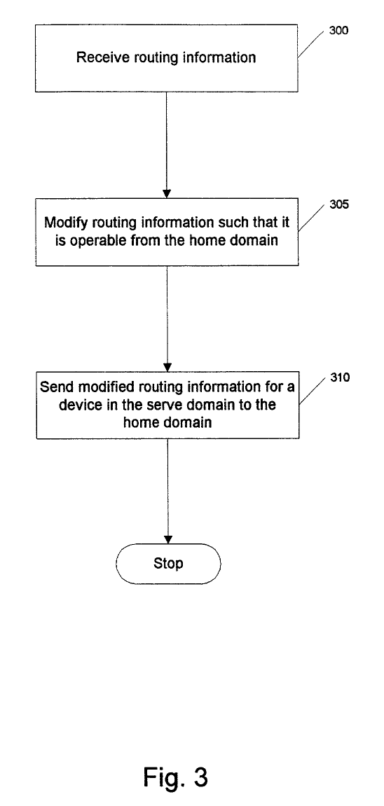

FIG. 3 is a flowchart of the high level steps performed by the International TLDN Translator in an exemplary embodiment of the present invention. The International TLDN Translator receives routing information from a domain (Step 300). The domain it receives routing information from is called the “serve” domain. For example, the serve domain is the domain where the mobile phone is roaming. In this scenario, a call is placed from the “home” domain and is attempting to reach a device or a roaming mobile phone in the serve domain. The serve domain provides the routing information to the International TLDN Translator based on the request received.

Next, the International TLDN Translator determines the home's capability and if necessary modifies the serve routing information so that it is operative from the home domain (Step 305). As described above, the routing information that is provided by the serve domain is not necessarily operative from other domains. This routing information provided by the serve domain is typically only operative from within the serve domain because the serve domain is not aware that international routing information is needed, does not know what is needed, or is not capable of sending what is needed.

The modified routing information is sent to the home domain in order that the home domain device may connect to the device in the serve domain (Step 310). After receiving the routing information to the device in the serve domain, a switch, in the home domain uses this routing information to then dial the device in the serve domain.

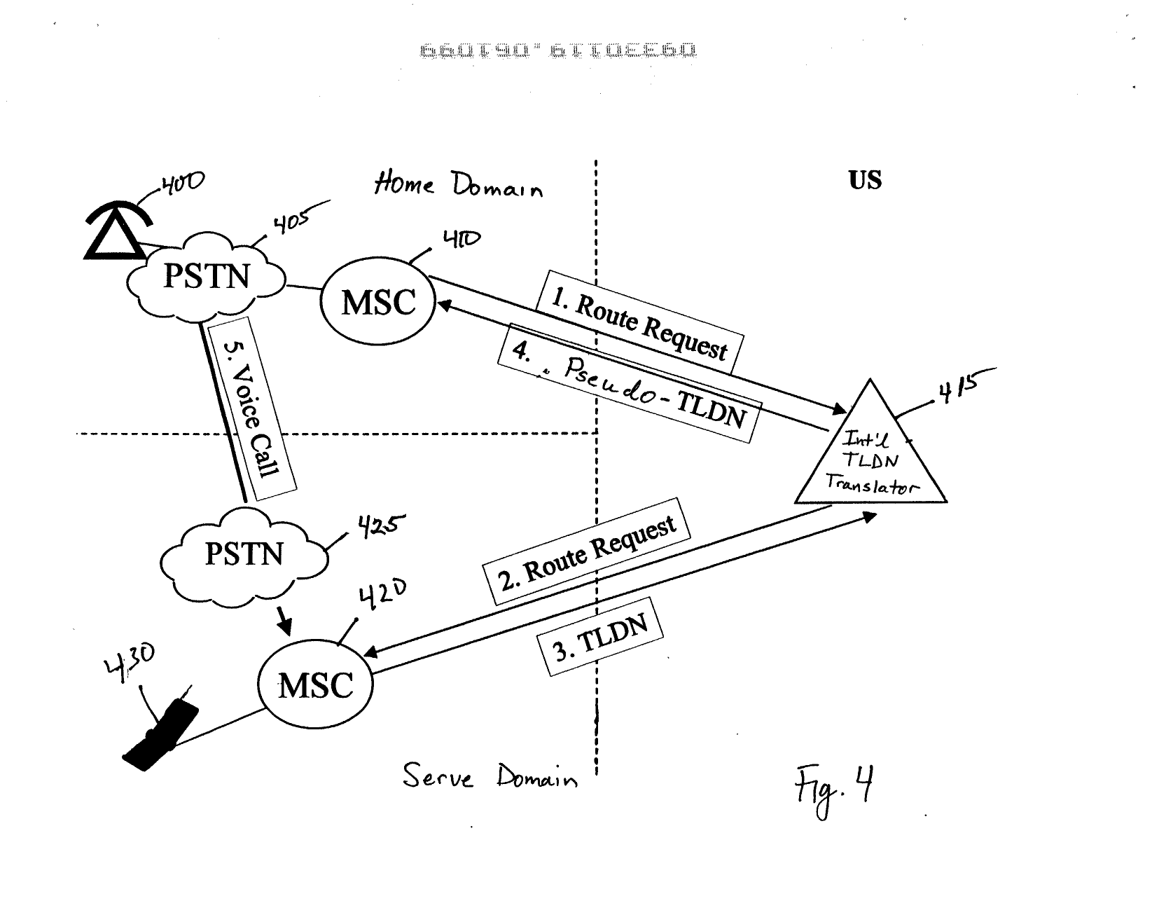

FIG. 4 is a pictorial diagram of a system implementing the International TLDN Translator in an exemplary embodiment of the present invention. A mobile phone 430 is roaming in a separate domain (the serve domain) from a device 400, e.g., a standard land line telephone. The device 400 makes a call to device 430 which is routed through PSTN 405 to the MSC 410 due to the fact that the number dialed for device 430 belongs to MSC 410 network. MSC 410 then tries to connect the call to the mobile phone 430. If both devices are within one domain, typically, MSC 410 and its associated HLR would be able to obtain and use the routing information as received from MSC 420 and dial into the public switching telephone network 405, accessing the public switch telephone network 425, which would terminate the voice call to the mobile phone 430 through MSC 420. However in this case, as is shown by the dash lines, the MSC 420 is located in an international serve domain and, typically, the MSC 410 and its associated HLR cannot determine the routing information for a device in an international domain.

The International TLDN Translator 415 makes it possible for the MSC 410 to access the roaming mobile phone 430. The process by which a call, such as a voice call, may be made to the mobile phone 430 is as follows. As is if the mobile phone was contained in the same domain, device 400 initiates a call by contacting the local network 405. The local network 405 then routes the call to the home MSC 410 of device 430. Because device 430 is outside of the domain, the MSC 410 and its associated HLR then sends the routing request to the International TLDN Translator 415. The International TLDN Translator 415 then forwards this routing request into the domain where the roaming mobile phone 430 is located. The MSC 420 at the serve domain then determines the routing information. This routing information is a TLDN that the serve domain's MSC assigns to the roaming mobile phone when a call needs to be terminated to that phone. Continuing, the MSC 420 sends the TLDN, i.e., the routing information, to the International TLDN Translator 415. As was discussed above, in today's environment this TLDN is generally operative from within the serve domain. However, once outside that domain, it is typically inoperative.

The International TLDN Translator 415 receives this TLDN sent to it by the serve domain's MSC and then determines whether and how to manipulate the TLDN so it is operative inside the home domain. The International TLDN Translator 415 will identify the serve and home domains and, from a database, retrieve the dialing characteristics and capabilities between the two domains involved. The International TLDN Translator 415 will modify the TLDN as necessary based on the retrieved dialing characteristics. The unmodified TLDN or “Pseudo-TLDN ” is then sent to the MSC 410 in the home domain. The MSC 410 in the home domain using the required TLDN, will route the call made by device 400 to the PSTN 425 in the serve domain via PSTN 405. The PSTN in the serve domain then accesses the MSC 420 in the serve domain to connect the call made by the device 400, by way of a circuit, to the device 430 in the serve domain.

It should be recognized that while the home and serve domains are not specifically identified and the International TLDN Translator 415 is indicated as being in the U.S., or a separate domain, the location of the International TLDN Translator 415 can be anywhere. This depiction is only for example purposes. The home and serve domain can be any separate domain, which sometimes equates to separate countries. The International TLDN Translator 415 can be at any location as long as there is connection between the home domain and the International TLDN Translator 415, and the serve domain and the International TLDN Translator 415. The actual location of the International TLDN Translator 415 is immaterial.

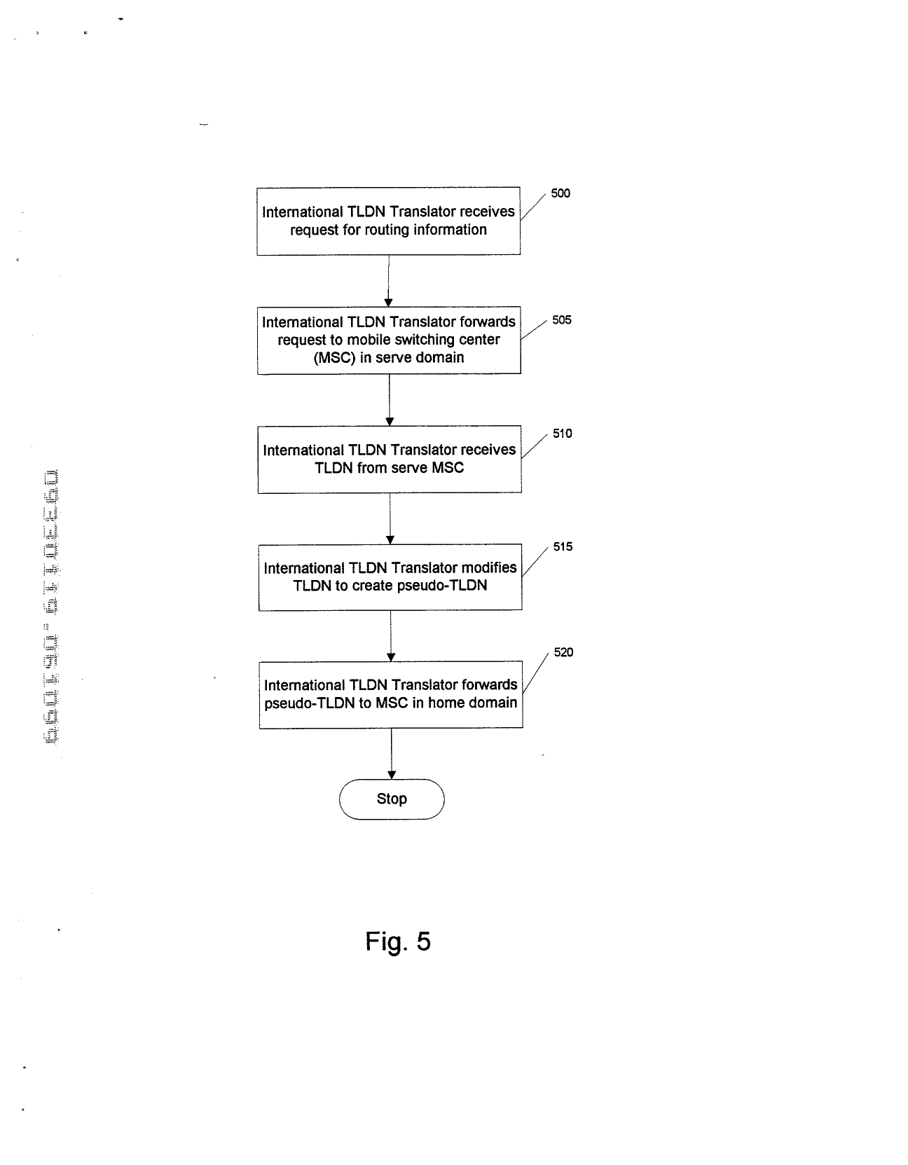

FIG. 5 is a flowchart of the steps performed to implement the TLDN translation between multiple domains in an exemplary embodiment of the present invention. The International TLDN Translator first receives the request for routing information from a home domain (Step 500). This request can come from any device, whether it be a local land line phone, another mobile phone or other device, i.e., a computer, that desires to contact another device in another domain. Pursuant to this request, the International TLDN Translator forwards the request to the mobile switching center (MSC) in the serve domain (Step 505). It will be recognized that while an MSC is used in this description, that there are many routing options that might be used to route information between two devices. These routing options include computers, routers, and other devices utilizing frame relay as well as other protocols for routing information. While an embodiment of the present invention is currently being described in terms mobile switching centers and public switching telephone networks, those skilled in the art will recognize that the use of a International TLDN Translator to manipulate routing information between domains will apply to any system that attempts to determine routing information whether they use switching centers, public networks, or other means.

After forwarding the request, the International TLDN Translator then receives a TLDN from the serve MSC (Step 510). As stated previously, a serve domain may provide a TLDN that is only operative from within that serve domain. There is no guarantee or indication whether that TLDN, operative within a serve domain, will be operative from outside that serve domain.

Having received the routing information from the serve domain, the International TLDN Translator then determines the need and may need to modify the received TLDN to create a pseudo-TLDN (Step 510) or an internationally formatted TLDN based on the capabilities of the switch in the home domain. The International TLDN Translator will modify a TLDN based on the home and serve domain characteristics. This would be, for example, by the addition of international dialing codes onto a TLDN that contained all other required digits i.e. the Country Code and phone number, creating a pseudo TLDN. Another example would be receiving a national TLDN, and modifying it by adding the CC and setting the “nature of number” bit to indicate an internationally formatted TLDN to access a device in another domain.

Next, the International TLDN Translator forwards the modified TLDN, or the received TLDN if no changes to the TLDN were required, to the MSC in the home domain (Step 520). The home domain, now having access to an operative TLDN, can dial the number of the roaming mobile device in the serve domain, from the home domain, without having to modify any of the serve routing information itself The International TLDN Translator has performed these modifications to create the required TLDN. If an international TLDN, defined by the “nature of number” bit was passed through by the International TLDN Translator, then the switch in home domain will add the International Dialing Digit required in its domain to connect the call.

In one embodiment, systems and methods consistent with the present invention receive TLDNs in various formats (e.g., National, International and Pseudo) from the Serve Domain and, based on the received format and the capability of the Home Domain switch, transmits an appropriate TLDN format to the Home domain. For this embodiment, Table 1 depicts a TLDN format to send to a Home Domain based on the Home Domain switch capability and the TLDN format received from the Serve Domain. Table 1 also depicts the required modification to the Serve Domain TLDN format in order to create the appropriate TLDN for the Home Domain.

TABLE 1

| | TLDN Format | | |
|---|---|---|---|
| Home Domain Switch | Received from Serve | TLDN Format to Send | Modification to Serve |
| Capability | Domain | to Home Domain | Domain TLDN |
| International & | 1- International | 1- International | 1- Non required |
| Pseudo & National | 2- National | 2- International | 2- Add CC & set |
| | | | nature of number |
| Pseudo & National | 1- International | Pseudo | 1- Add IDD |
| | 2- National | Pseudo | 2- Add IDD & CC |
| National Only | 1- International | 1- Modified National | 1- As received |
| | 2- National | 2- National | without setting |
| | | | nature of number |
| | | | 2- As received |
| | | | Note: Call delivery |
| | | | will most likely fail |
| | | | due to limitation of |
| | | | switch in home |
| | | | domain |

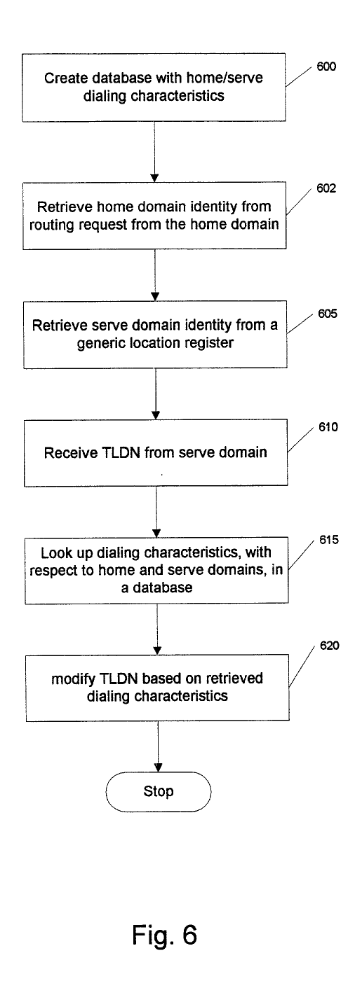

FIG. 6 is a flowchart depicting the steps performed by the International TLDN Translator in creating the appropriate TLDN for the home domain in an exemplary embodiment of the present invention. A database is created for the International TLDN Translator (Step 600). This database will contain the serve and home domain dialing characteristics for the domains supported by the International TLDN Translator. For example, some domains will require the addition of international digits and some domains will require more manipulations in order that a voice call may be placed from one domain to another. Furthermore, depending on the home domain, different manipulations will be necessary to place a call from that home domain to a serve domain. For example, as discussed above, making a call from the U.S. to Hong Kong will require different manipulations to the called phone number versus a call from Venezuela to Hong Kong. Therefore, even though the same serve country is used, e.g., Hong Kong, the fact that the call originated from separate home domains, U.S. and Venezuela, require different manipulations to the called phone number.

After creating the database, the International TLDN Translator retrieves the home domain identity from the routing request sent to it from the home domain (Step 602). The International TLDN Translator then retrieves the serve domain identity from a generic location register (Step 605). The generic location register determines the identity of a domain via a registration notification message that has been sent when the roaming mobile phone entered an MSC coverage area in that domain.

Next, the International TLDN Translator will receive the TLDN from the serve domain Step (610). Having the home and serve domain identities and the TLDN, the International TLDN Translator will then look up the dialing characteristics, with respect to the home and serve domains, in the database created in Step 600 (Step 615). After the dialing characteristics are retrieved from the database, the International TLDN Translator will then determine the need and accordingly modify the TLDN based on the retrieved dialing characteristics from the database and the capabilities of the switch in the home domain (Step 620). This modified TLDN, i.e., the pseudo-TLDN, is operative and will therefore be used to connect the device in the home domain to the roaming device in the serve domain.

Conclusion

Systems and methods to translate routing information that is operative from outside a specific domain in a manner consistent with the present invention facilitates the ability of a device to roam into a different domain from a device that is trying to contact the roaming device. By providing an International TLDN Translator, users can take a device such as a mobile phone, and roam into a separate domain from the users that are trying to contact them. The users contacting the roaming mobile phone or the wireless switches in their domain will not have to add or delete any additional information to the routing information provided by the roaming domain because the translation is performed by the International TLDN Translator. Also, the routing information may be used in the transporting of data, voice, video, or any other kind of information to the temporary device.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but one embodiment of the present invention may be implemented as a combination of hardware and software or in hardware alone. The invention may be implemented with both object-oriented and non-object-oriented programming systems. Additionally, although aspects of the present invention are described as being stored in memory, those skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

What is claimed is:

1. A method for determining an operative routing number from a home domain for a device in a serve domain, comprising:
receiving a request for a routing number for a device located in the serve domain;
receiving the routing number from the serve domain, the serve domain's routing number being inoperative from the home domain; and
generating an operative routing number, from the home domain, for the device.

2. The method of claim 1, further comprising the step of transmitting the operative routing number to the home domain.

3. The method of claim 1, wherein the step of modifying the routing number comprises the following steps:
determining the identities of the serve domain and the home domain;
determining dialing characteristics from the home domain to the serve domain; and
modifying the routing number using the serve and home domains' routing characteristics.

4. The method of claim 1, wherein the routing number is a Temporary Local Directory Number (TLDN) and the operative routing number is a pseudo-TLDN.

5. The method of claim 1, wherein the home domain is associated with one numbering plan area and the serve domain is associated with another numbering plan area.

6. A method for contacting a mobile device in a serve domain from a device in a home domain, comprising:
receiving a routing request for the mobile device;
sending the routing request to a component servicing the mobile device in the serve domain;
receiving a Temporary Local Directory Number (TLDN) from the serve domain;
creating a pseudo-TLDN by modifying the TLDN such that the pseudo-TLDN is operative from the device located in the home domain; and
transmitting the pseudo-TLDN to a component servicing the device in the home domain so that the device in the home domain is capable of contacting the mobile device using the pseudo-TLDN.

7. The method of claim 6, wherein the step of creating the pseudo-TLDN comprises the following steps:
determining the identities of the serve domain and the home domain;
determining dialing characteristics from the home domain to the serve domain; and
modifying the TLDN using the serve and home domains' routing characteristics.

8. The method of claim 6, wherein the home domain is associated with one numbering plan area and the serve domain is associated with another numbering plan area.

9. The method of claim 6, wherein the component that services the device in the home domain is a mobile switching center and the component that services the mobile device in the serve domain is a mobile switching center.

10. The method of claim 9, further comprising the step of contacting the mobile device by using the pseudo-TLDN dialed from the mobile switching center in the home domain

11. A method of passing routing information for a roaming device located in a serve domain from a device located in a home domain, comprising:
receiving by a call processor from a mobile switching center (MSC) servicing a home domain a routing request to contact the roaming device;
transmitting to an MSC in the serve domain the routing request;
receiving by the call processor from the serve domain MSC a Temporary Local Directory Number (TLDN) for the roaming device;
creating a pseudo-TLDN by modifying the TLDN such that the pseudo-TLDN can be dialed from the home domain and reach the roaming device in the serve domain; and
transmitting the pseudo-TLDN to the home domain MSC.

12. The method of claim 11, wherein the home domain is associated with one numbering plan area and the serve domain is associated with another numbering plan area.

13. The method of claim 11 further comprising the step of transmitting the pseudo-TLDN to an MSC in the home domain to initiate a call to the roaming device.

14. The method of claim 13, wherein the call may be a data stream or a voice call.

15. A method for creating a pseudo-TLDN (Telephone Local Directory Number) so that a device in a home domain may contact a roaming device in a serve domain, comprising:
receiving a routing request from a home domain;
receiving a TLDN for the roaming device in the serve domain;
determining the identity of the serve domain and the home domain;
determining dialing characteristics when dialing from the home domain to the serve domain; and
modifying the TLDN using the serve and home domains' characteristics to create the pseudo-TLDN.

16. The method of claim 15, wherein the roaming device is a wireless phone.

17. The method of claim 15, wherein the step of modifying of the TLDN is performed by an International TLDN Translator;

18. The method of claim 15, wherein the home domain is associated with one numbering plan area and the serve domain is associated with another numbering plan area.

19. The method of claim 15, wherein the identity of the server domain is retrieved from a generic location register.

20. The method of claim 15, wherein the identity of the home domain is retrieved from the routing request received from the home domain.

21. An switch containing computer executable instructions that when executed perform the steps of:
receiving a request for routing information for a device located in a serve domain;
transmitting the request for routing information to a TLDN Translator;
receiving a modified TLDN operative in the home domain to the device in the serve domain; and
transmitting the modified TLDN to a network in the home domain to contact the device in the serve domain.

22. The switch of claim 21, wherein the modified TLDN is a psuedo-TLDN.

23. The switch of claim 21, wherein the modified TLDN is an International TLDN.

24. A method in a computer system of generating home routing information from a serve routing information received from a switch in the serve domain, comprising the steps of:
receiving the serve routing information from the serve domain switch;
identifying a format operative at the home domain switch;
generating the home routing information in the format operative at the home domain switch using the serve routing information; and
transmitting the home routing information in the acceptable format to the home domain switch.

25. The method of claim 24, wherein the serve routing information in an International TLDN and the format acceptable to the home domain switch is a pseudo-TLDN format.

26. The method of claim 24, wherein the serve routing information is an National-TLDN and the format operative to the home domain switch is a psuedo-TLDN format.

27. The method of claim 24, wherein the serve routing information and the home routing information are the same.

28. The method of claim 24, wherein the serve routing information is a National-TLDN and the format acceptable to the home domain switch is an International TLDN format.

29. A phone connected to a network, comprising:
an input;
an output; and
a processor operative to perform the steps of:
initating a call to a device in a serve domain;
connecting to the device in a serve domain,
wherein a switch connected to the device in the serve domain provided routing information that is inoperative from the home domain.

30. A method for determining an operative routing number from a home domain for a device in a serve domain, comprising:
means for receiving a request for a routing number for a device located in the serve domain;
means for receiving the routing number from the serve domain, the serve domain's routing number being inoperative from the home domain; and
means for generating an operative routing number, from the home domain, for the device.
